(19) United States
(12) Patent Application Publication
(10) Pub. No.: US 2011/0268526 A1
(43) Pub. Date: Nov. 3, 2011

(54) Injection Molded Torque Nut with Internal Recession

(75) Inventors: Yaokun Wu, Ontario (CA); Marc W. Lamothe, Ontario (CA); Robert M. Gagnon, Ontario (CA)

(73) Assignee: FCI HOLDINGS DELAWARE, INC., Pittsburgh, PA (US)

(21) Appl. No.: 12/772,406

(22) Filed: May 3, 2010

(51) Int. Cl. F16B 33/04; B23P 11/00; B23P 17/00

(52) U.S. Cl. 411/1; 470/20; 29/525.12

(57) ABSTRACT

A torque nut includes a threaded passageway and a groove. The groove has its opening facing the passageway. A breakaway insert having a major body portion is formed in the passageway, and a tab connected to the major body portion is formed in the groove, for example, by injection molding. The tab connected to the major body portion prevents rotation of the insert in the passageway. In one use, a resin component, a catalyst component and a first end of a rock-bolt are positioned in a bore hole. The torque nut is threaded onto the opposite end of the rock-bolt. Rotation of the torque nut rotates the rock-bolt, mixing the components. After the components set, increased torque is applied to the torque nut to fracture the insert and move the nut up the threaded end of the rock-bolt against roof stabilizing components.

### BACKGROUND OF THE INVENTION

1. Field of the Invention

This invention relates to an injection-molded torque nut with an internal recession, and more particularly, to a torque nut or buddy nut having an injection-molded breakaway insert with tabs received in the internal recession to interlock the insert and the body of the nut, and to a method of manufacturing the torque nut.

2. Description of Related Art

It is well known in the art of mine roof support to anchor rock-bolts in bore holes drilled in the mine roof to reinforce the unsupported rock formation above the mine roof surface, e.g., as disclosed in U.S. Pat. No. 7,261,494, which patent is hereby incorporated by reference. Conventionally, a bore hole is drilled through the roof into the rock formation. An end of the rock-bolt is inserted into the bore hole in the rock formation and anchored or secured within the bore hole by either engagement of an expansion shell on the end portion of the bolt with the rock formation, or adhesively bonding the end portion of the bolt by resin to the rock formation, or by utilizing a combination of the expansion shell and the resin bonding. Of particular interest in this discussion is the torque nut used to anchor an end portion of the bolt in the mine roof and to secure mine roof stabilizing components on the opposite end portion of the bolt.

In general and as discussed in U.S. Pat. No. 5,064,312, which patent is hereby incorporated by reference, the technique of securing the anchor or rock-bolt in the bore hole includes inserting a capsule into a bore hole drilled into the mine roof. The capsule contains a resin component and a catalyst component. An end of the rock-bolt is moved into the bore hole to move the end of the rock-bolt into contact with the resin capsule. The rock-bolt is rotated and further moved into the bore hole to fracture the resin capsule and to mix the resin component and the catalyst component together to provide a grout or adhesive, which will set and harden within the bore hole. After the grout sets, a nut is threaded onto the end portion of the rock nut extending out of the hole to bias mine roof stabilizing components, e.g., a bearing plate or truss shoe, against the mine roof or wall having the bore hole.

One technique to rotate the rock-bolt to fracture the capsule and/or to mix the resin and catalyst is disclosed in U.S. Patent Application Publication No. 2006/0210374A1. In general, a nut having an injection-molded polymer insert or delay stopper plug at an end portion of the nut is rotated onto the threaded end of the rock-bolt extending out of the bore hole. Continued rotation of the nut moves the end of the rock-bolt and the insert into contact with one another, after which rotation of the nut rotates the rock-bolt. After the resin hardens to secure the rock-bolt in the bore hole, continued rotation of the nut under increased torque breaks up the insert. The pieces of the broken insert fall out of the nut, and the nut can be rotated on the threaded end of the anchor to move the roof stabilizing components against the mine roof or wall.

Although the nut having the insert or plug disclosed in U.S. Patent Application Publication No, 2006/0210374A1 is acceptable to fracture the capsule and/or to mix the resin and catalyst, there are limitations. More particularly, it is preferred to minimize the outer diameter contact surface area between the end of the threaded rock-bolt and the outer diameter surface of the insert or delay plug to reduce applied reaction torque on the insert while rotating the nut. The applied reaction torque on the insert results from the friction realized from the outer diameter surface contact between the end portion of the rock-bolt and the contacted surface of the insert. The increased applied reaction torque results in rotational unscrewing motion of the insert from the nut.

As can be appreciated by those skilled in the art, it would be advantageous to provide a nut having an insert, or delay stopper plug secured in the nut, such that the plug does not move out of the nut as the nut is rotated onto the end of the rock-bolt.

### SUMMARY OF THE INVENTION

This invention relates to a torque nut or buddy nut, having among other things, a body having a first end, an opposite second end, an outer surface between the first end and the second end, and an interior passageway connecting the first and second ends of the body. The passageway has a threaded surface portion, and at least one groove extending from the first end toward the second end, wherein the at least one groove is spaced from the outer surface of the body and has an opening communicating with the interior passageway. A breakaway insert includes a major body portion and a tab connected to the major body portion of the insert, wherein the major body portion of the insert is in the passageway of the nut and the tab is in the at least one groove. With this arrangement, the tab connected to the major body portion of the insert and in the groove of the nut prevents rotation of the insert in the passageway of the nut.

Further, this invention relates to a method of making a torque nut or buddy nut having a breakaway insert by, among other things, providing a nut body having a first end, an opposite second end, an outer wall between the first end and the second end, a passageway connecting the first end and the second end of the nut body, the passageway having a threaded portion, and at least one groove extending from the first end toward the second end, wherein the at least one groove is spaced from the outer wall of the nut body and has an opening facing the interior of the passageway. A breakaway insert is formed in the passageway, wherein a portion of the insert defined as a major body portion is in the passageway and a portion of the insert defined as a tab is in the at least one groove. The tab in the at least one groove of the nut prevents rotation of the insert in the passageway of the nut.

Still further, this invention relates to a method of securing an anchor in a structure by, among other things, providing a torque nut or buddy nut having, among other things, a body having a first end, an opposite second end, an outer surface between the first end and the second end, an interior passageway connecting the first and second ends of the body, the passageway having a threaded surface portion, and at least one groove extending from the first end toward the second end, wherein the at least one groove is spaced from the outer surface of the body and has an opening communicating with the interior passageway. A breakaway insert has a major body portion and a tab connected to the major body portion, wherein the major body portion of the insert is in the passageway of the nut and the tab is in the at least one groove, wherein the tab connected to the major body portion and in the at least one groove prevents rotation of the insert in the passageway. An end of a rock-bolt or anchor is threaded into an end of the nut body. An opposite end of the anchor is positioned in a bore hole in the structure, e.g., a mine roof with the opposite end of the anchor engaging a capsule having a resin component and a catalyst component. The nut is rotated to rotate the anchor to fracture the capsule and/or to mix the resin and catalyst components to secure the opposite end of the anchor in the bore hole.

### BRIEF DESCRIPTION OF THE DRAWING(S)

FIG. 1 is an orthogonal view, having portions removed for purposes of clarity, of a non-limiting torque nut or buddy nut of the invention;

FIG. 2 is an end view of the nut shown in FIG. 1;

FIG. 3 is a cross-sectional side view of the nut shown in FIG. 1;

FIG. 4 is a view similar to the view of FIG. 3 of another non-limiting embodiment of a torque nut of the invention;

FIG. 5 is a view similar to the view of FIG. 3 showing still another non-limiting embodiment of a torque nut of the invention positioned below the end of an anchor or rock-bolt;

FIG. 6 is a plane view of another non-limiting embodiment of a torque nut of the invention;

FIG. 7 is a view similar to the view of FIG. 3 showing still another non-limiting embodiment of a torque nut of the invention threaded on the end of a rock-bolt and FIG. 7A is an enlarged view of the area circled in FIG. 7;

FIGS. 8-13 are cross-sectional views through the radial center line of non-limiting embodiments of inserts or delay stopper plugs of the invention;

FIGS. 14A-14F show a non-limiting embodiment of the invention to injection mold an insert or delay stopper plug in a nut body;

FIG. 15 is a partial cross-sectional view of a mine roof having an end of rock-bolt and capsule mounted in a bore hole in the mine roof, and a roof stabilizing component on, and a toque nut of the invention spaced from, the threaded other end of the anchor.

### DESCRIPTION OF THE PREFERRED EMBODIMENT(S)

As used herein, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 6.7, or 3.2 to 8.1, or 5.5 to 10.

Before discussing non-limiting embodiments of the invention, it is understood that the invention is not limited in its application to the details of the particular non-limiting embodiments shown and discussed herein since the invention is capable of other embodiments. Further, the terminology used herein to discuss the invention is for the purpose of description and is not of limitation. Still further, unless indicated otherwise in the following discussion, like numbers refer to like elements.

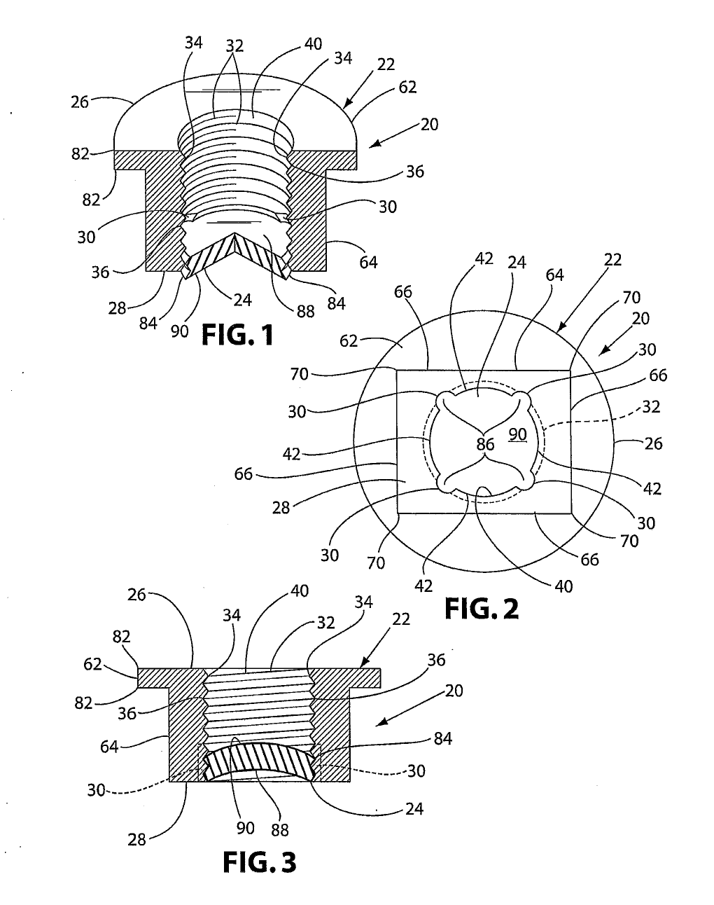

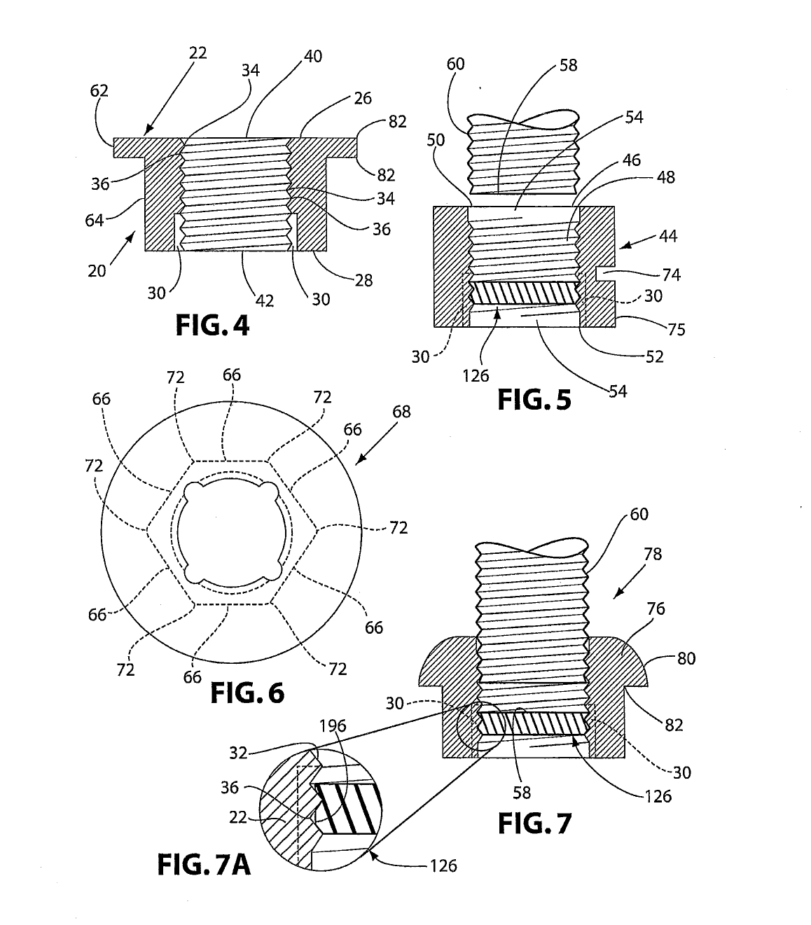

With reference to FIGS. 1-4, as needed, there is shown a torque nut or buddy nut 20 incorporating features of one non-limiting embodiment of the invention. The nut 20 includes a nut body 22 and an injection-molded insert or delay stopper plug 24 captured in the nut body 22 (see FIGS. 1-3) in a manner discussed below. The nut body 22 has a flanged open end (hereinafter also referred to as a “first end”) 26, an opposite open end (hereinafter also referred to as a “second end”) 28, internal spaced grooves 30 (clearly shown in FIGS. 2 and 4) extending from the second end 28 to the first end 26 of the nut body 22, and internal threads 32. The threads 32 have a substantially uniform thread height and pitch. The term “thread height” is defined as a measured distance between the minor inner thread diameter, e.g., highest point or apex 34, of the threads 32, and the maximum inner thread diameter, e.g., the corresponding lowest point or nadir 36, of the threads 32. The term “pitch” as defined herein is the spacing between apexes 34 of adjacent threads 32.

In one non-limiting embodiment of the invention, the internal threads 32 extend from the flanged open end 26 to the opposite open end 28 to provide the nut body 22 with an internally-threaded passageway 40. The continuity of the internal threads 32 adjacent the second open end 28 is interrupted by the internal spaced grooves 30 to provide a segment 42 (clearly shown in FIGS. 2 and 4) of internal threads 32 between adjacent ones of the internally spaced grooves 30. The internal threads 32 shown in FIGS. 1, 3, and 4 extend from the second end 28 to the first end 26. The invention, however, is not limited to the threads 32 extending from the second end 28 to the first end 26, and the invention contemplates having the internal threads 32 starting a spaced distance from one or both of the ends 26 and 28 of the nut body 22. More particularly and not limiting to the invention, torque nut 44 shown in FIG. 5 has internal passageway 46 having a threaded portion 48 starting at a position spaced from one end, e.g., open end 50 and extending toward opposite open end, e.g., opposite open end 52 and ending at a position a spaced distance from the end 52 to provide an unthreaded internal portion 54 at each end of the internal passageway 46. The unthreaded portions 54 of the passageway 46 have a diameter equal to or greater than the diameter of the maximum inner threads or nadir 36 to pass end portion 58 of a threaded shaft 60.

Referring back to FIGS. 1-4 as needed, the outer configuration of the nut body 22 is not limiting to the invention and preferably the flanged open end 26 includes a flange 62, and a shaped outer surface 64 between the flange 62 and the second end 28 that can be engaged, e.g., by a wrench and/or ratchet, to rotate the torque nut 20 onto the threaded end portion 58 of the threaded shaft 60 (see FIG. 5) to apply a predetermined torque to the nut 20 to fracture the insert 24 of the nut 20 in a manner discussed below. In the non-limiting embodiment of the invention shown in FIGS. 1-4, the shaped outer surface 64 has four flat sides 66 (clearly shown in FIG. 2). As can be appreciated, the invention is not limited to the number of flat sides 66, and the shaped outer surface 64 of the nut body 22 can have any number of flat sides 66, for example and not limiting to the invention, the torque nut can have more or less than the four flat sides 66 shown in FIG. 2, for example and not limiting to the invention, the torque nut can have six flat sides 66 as shown in FIG. 6 for torque nut 68. Further corners formed by the flat sides 66 can be at an angle as shown for corners 70 in FIG. 2 or rounded as shown for corners 72 in FIG. 6.

As can now be appreciated, the flat side(s) 66 facilitate rotating the torque nut 20 to apply the predetermined torque; the invention, however, is not limited thereto and contemplates the outer body portion of the torque nut being circular, e.g., as shown for the torque nut 44 of FIG. 5 and having one or more grooves 74 (only one groove shown in FIG. 5) in outer surface 75 of the nut 44 to provide an engaging surface for the torque applying tool to rotate the torque nut of the invention. Further, as can be appreciated, the invention is not limited to the shape of the flange, e.g., the flange 62 of the torque nut 20, and the flange can have any shape, for example and not limiting to the invention, flange 76 for torque nut 78 shown in FIG. 7 has one radius peripheral edge 80 and an opposite angular peripheral edge 82, whereas the flange 62 in FIGS. 1, 3, and 4 has opposed angular peripheral edges 82.

The material of the body 22 of the torque nut 20 is not limiting to the invention and is usually made of metal, e.g., steel, to provide the required physical properties. For more detailed specifications on the physical properties of nuts used on ends of rock-bolts or anchors, reference can be had to ASTM F432 for torque nuts made and/or used in the United States of America and to CAN/CSA-M430-90 for torque nuts made and/or used in Canada.

The discussion is now directed to non-limiting embodiments of the insert or stopper delay plug 24 of the invention. The insert 24 of the invention is secured in the threaded passageway 40 by the segments 42 of the internal threads 32 (see FIG. 2) and periphery 84 (see FIG. 1) of the insert 24 engaging one another, and rotational movement of the insert 24 along the internal threads 32 is prevented by tabs 86 of the insert 24 in the internally spaced grooves 30 (see FIG. 2). The insert 24 of the invention is shown in FIG. 2 with four tabs 86, the invention, however, is not limited thereto, and the insert 24 can have more or less than four tabs, e.g., one, two, or three tabs, or more than four tabs, e.g., five, six, seven, or eight tabs.

The invention is not limited to the shape of the major surfaces 88 and 90 of the insert 24, however, the major surfaces 88 and 90 are contoured for fracturing the insert 24 and having the fractured portions of the insert 24 falling out of the internally threaded passageway 40. Optionally, the tabs 86 can remain in their respective grooves 30 or can fracture and fall out of the groove depending on the fracture pattern of the insert 24.

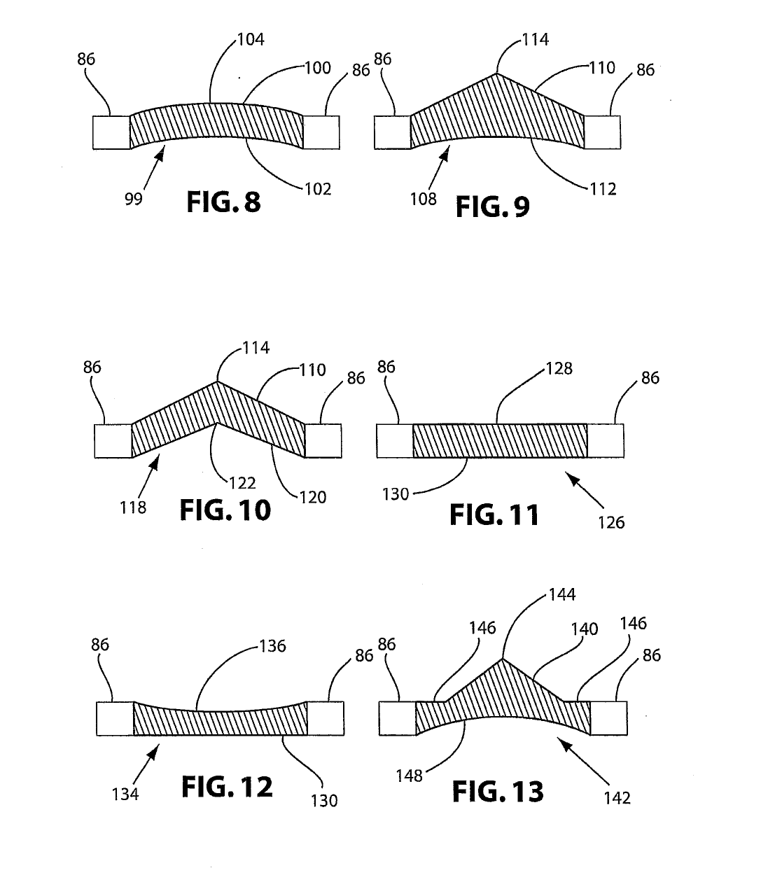

FIGS. 8-13 show various cross-sections of non-limiting embodiments of the insert of the invention. For purposes of clarity and not limiting to the invention, the upper surface of the inserts shown in FIGS. 8-13 are engaged by the end portion 58 of the threaded shaft 60 (see FIGS. 5 and 7). With reference to FIG. 8, the insert 99, which is similar to the insert 24 (see FIG. 3) has an upper convex major surface 100 and an opposite concave major surface 102. The upper convex major surface 100 has an elevated radius center portion 104 with non-uniform incrementally increasing diameter as the distance from the center portion 104 increases to provide the convex major surface 100 with a half-spherical elevated surface. Although not limiting to the invention, opposite lower concave surface 102 is generally parallel to the upper convex surface 100, e.g., the surface 102 has a half-spherical depressed surface.

Insert or delay plug 108 shown in FIG. 9 has an upper convex major surface 110, and a lower concave major surface 112 having the half-spherical depressed surface. The upper convex major surface 110 has an elevated center point 114 with a uniformly incrementally increasing diameter as the distance from the center point 114 increases to provide the upper convex major surface 110 with an elevated cone-shaped major surface 110 as shown in FIG. 9.

Insert or delay plug 118 shown in FIG. 10 has the upper convex major surface 110 having the elevated cone-shaped major surface, and an opposite concave major surface 120. The lower concave major surface 120 has a depressed center point 122 with a uniformly incrementally increasing diameter as the distance from the center point 122 increases. In one non-limiting embodiment of the invention, the lower concave major surface 120 is generally parallel to the upper convex major surface 110 of the insert 118. Insert or delay plug 126 shown in FIG. 11 has a flat upper major surface 128, and an opposite lower flat major surface 130. Although not limiting to the invention, the major surfaces 128 and 130 are generally parallel to one another to provide the insert 126 with a disc or hockey puck configuration.

Insert or delay plug 134 shown in FIG. 12 has an upper concave major surface 136, and the lower flat surface 130. As can be appreciated, the invention is not limited to the shape of the major surfaces of the insert and in particular of the upper major surface of the plug facing the end portion 58 of the threaded shaft 60 (see FIGS. 5 and 7). For example and not limiting to the invention, upper major surface 140 of the insert 142 shown in FIG. 13 has a center elevated cone-shaped portion 144 similar to the upper major surface 110 of the inserts 108 and 118, shown in FIGS. 9 and 10 respectively, surrounded by flat surface portions 146 similar to the flat upper surface 128 of the insert 126 shown in FIG. 11, and a lower half-spherical depressed major surface 148 similar to the surface 112 of the insert 108 shown in FIG. 9.

In the following discussion, reference is made to the insert 24; the discussion, however, is applicable to the inserts 99, 108, 118, 126, 134, and 142 of FIGS. 8-13, respectively, unless indicate otherwise. The non-limiting embodiments of the invention discussed below eliminate the rotational unscrewing motion of the insert from the nut body 22 by the tabs 86 of the insert engaging the internal grooves 30 of the nut body 22 (see FIGS. 1-4).

The inserts or stopper delay plugs of the invention are injection molded into the threaded passageway 40 of the nut body 22 and into the internally spaced grooves 30 (see FIG. 4) in a manner discussed below. The insert 24 is captured in the passageway 40 of the nut 22 by the internal threads 32 engaging the periphery 84 (see FIG. 1) of the insert 24, and the insert 24 is prevented from rotating within the passageway 40 by the tabs 86 (see FIG. 2) of the insert captured in the internal grooves 30. As can be appreciated by those skilled in the art, the irregularities in the physical dimensions of the threads 32 associated with machining the nuts and the machining oil having metal debris left on and/or between the threads provide some friction to resist rotation of the inserts 24 in the threaded passageway 40. Because rotation of the insert 24 is prevented by the tabs 86 mounted or captured in the spaced grooves 30 in the nut body 22, the inserts 24 are not screwed out of the nut body 22, but are sheared at the threads, fracturing the insert 24, after which the pieces of the insert captured by the threads fall out of the nut body 22. The tabs 86 captured in the internal grooves 30 can remain in grooves or fall out of the grooves 30. More particularly and not limiting to the invention, a torque force is applied to the torque nut 20 as it is threaded onto the threaded end portion 58 of the threaded shaft 60 causing the threaded end portion 58 to fracture the insert 24, with the loose fractured pieces falling out of the nut body 22. Since force is required to fracture the inserts, the shape of the inserts has to be taken into consideration. For example and not limiting to the invention, and as is appreciated by those skilled in the art, the half-spherical major surfaces 100 and 102 of the inserts 24 and 99 shown in FIGS. 3 and 8 provide a stronger surface than the flat surfaces 128 and 130 of the insert 126 shown in FIG. 11. Therefore, for inserts 24, 99, and 126 of the same thickness, more torque force is required to fracture the inserts 24 and 99 than the insert 126. Further, the inserts 24 and 99 are stronger than the insert 118 having the cone-shaped major surfaces 110 and 120 (see FIG. 10), and the insert 118 is stronger than the insert 126 (see FIG. 11). Therefore, for inserts 24, 99, 118, and 126 having the same thickness, more shear torque force is required to fracture the insert 118 (FIG. 10) than the insert 126 (FIG. 11). As is now appreciated, the force required to separate the tabs 86 (see FIG. 2) from the rest of the insert is generally the same for each insert, e.g., the inserts 24, 99, 118, and 126 under discussion. From the foregoing provided information, those skilled in the art can determine the strength of inserts having different major surfaces, for example but not limiting to the invention, the inserts shown in FIGS. 8-13.

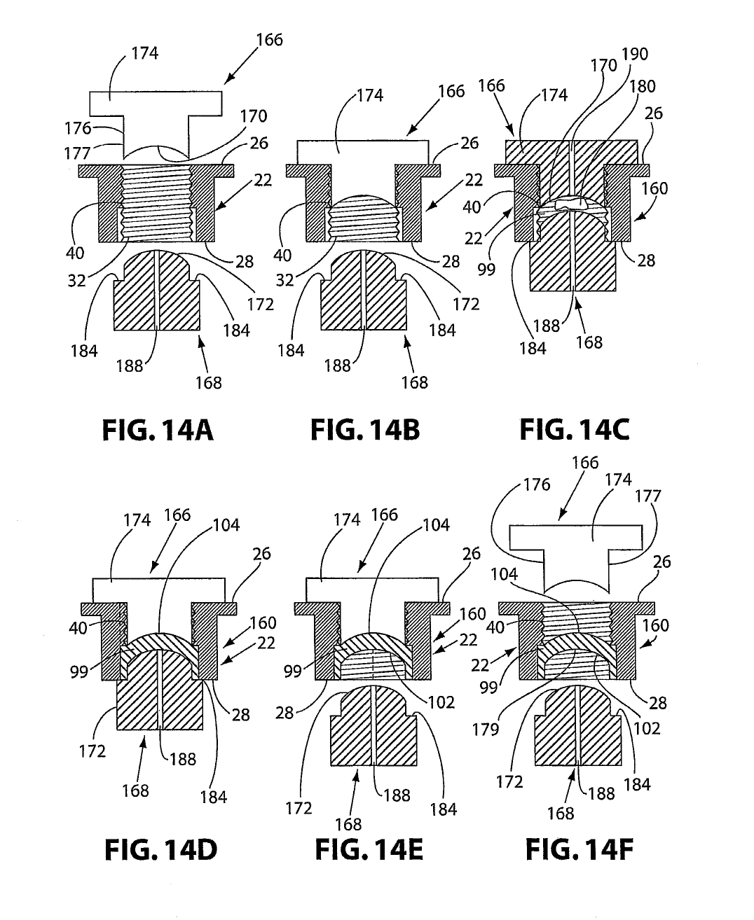

In the preferred practice of the invention, the insert is injection molded into the passageway 40 and the grooves 30 of the nut body 22. With reference to FIGS. 14A-14F, as needed, the discussion is directed to fabricating torque nut 160 having the insert 99 (see FIGS. 8 and 14D-14F) which includes the nut body 22 having the surface 102 of the insert 99 (see FIGS. 8 and 14F) spaced from the second end 28 of the nut body 22. As is appreciated, the following discussion is applicable to fabricating a nut having an insert of any shape, e.g., but not limiting to the invention, the inserts shown in FIGS. 8-13.

The second end 28 of the nut body 22 of the nut 160 having the internally threaded passageway 40 (see FIG. 14A) is machined to provide the four internally spaced grooves 30 (see FIGS. 2 and 14A). The length of the grooves 30 as measured from the second end 28 of the nut body 22 in a direction toward the first end is not limiting to the invention and is at least equal to the thickness of the insert 99. In one non-limiting embodiment of the invention, the insert 99 had a thickness as measured between the surfaces 102 and 104 of ¼ inch, and the grooves 30 had a length of ⅜ of an inch and a diameter of 1/16 of an inch. As can be appreciated, the invention is not limited to the length and diameter of the grooves 30, and the grooves 30 can extend from the second end of the nut body to the first end of the nut body as shown in phantom in FIG. 5.

Referring back to FIGS. 14A-14F as needed, the nut body 22 is held in position in any convenient manner between forming die 166 and injection die or needle 168. End 170 of the forming die 166 is contoured to provide the surface 104 of the insert 99, and the injection die 168 has injection end 172 contoured to provide the surface 102 of the insert 99, shown in FIG. 14F. The end 170 of the forming die 166 is inserted into the flanged open end 26 of the nut body 22 with transverse member 174 resting on the flanged end 26 of the nut body 22 to set the end 170 of the forming die 166 a predetermined distance from the second end 28 of the nut body 22 as shown in FIG. 14B. Although not limiting to the invention, the outside diameter of shaft 176 of the forming die 166 is in the range of, or equal to, 90% of the diameter of the threaded passageway 40 as measured at the apex 34 of the internal threads 32 (see FIG. 1). A close fit between outer surface 177 of the shaft 176 of a forming die 166 and the passageway 40 of the nut body 22 prevents material injected into the cavity mold 180 (only numbered in FIG. 14C) formed by the ends 170 and 172 of the forming die 166 and the injection die 168, respectively, from moving from the cavity mold 180 and the grooves 30 up the passageway 40 between the threads 32 and the outer surface 177 of the shaft 176 of the forming die 166 and prevents the injected material from depositing on the threads above the insert 24. In one non-limiting embodiment of the invention, the end 170 of the forming die 166 does not extend over the grooves 30 to prevent the injected resin from moving in the grooves toward the first end of the nut body 22 and moving between the outer surface 177 of the shaft 176 and the threads 32. As is now appreciated, material on the threads 32 above the insert 99 can require an increase in torque force to move, e.g., screw, the end portion 58 of the threaded shaft 60 into engagement with the insert 99 and/or to fracture the insert 99, and the flowing of the resin between the internal threads 32 and the outer surface 177 of the shaft 176 of the forming die 166 can result in the formation of a thin layer of flash that forms a seal preventing the flow of polymer between the apex 34 of the threads 32.

In another non-limiting embodiment of the invention, the injection die 168 is at a temperature less than the temperature of the resin injected into the mold cavity 180. In this manner, as the polymer contacts the contoured end 172 of the injection die 168, a thin layer or flash is formed over the end 172 of the injection die 168 in the nut body 22 to prevent flowing of the polymer between the threads 32 of the nut body 22 and outer surface 177 of the shaft 176 of the forming die 166 while injecting the resin in the mold cavity 180 and the internal grooves 30.

With reference to FIG. 14C, the shaped end 172 of the injection die 168 (see FIG. 14B) is moved into the second end 28 of the nut body 22 to move ledge 184 surrounding the shaped end 172 into engagement with the second end 28 of the nut body 22. Although not limiting to the invention, the outside diameter of the shaped end 172 of the injection die 168 is in the range of, or equal to, 90% of the diameter of the threaded passageway 40 as measured at the apex 34 of the internal threads 32 (clearly shown in FIG. 1) for the reasons discussed above for the forming die 166 and to move the ledge into surface contact with the second end 28 of the nut body 22 as shown in FIG. 14C to prevent material injected into the cavity mold 180 from moving from the cavity mold 180 and the grooves 30 toward and out of the grooves 30 and the passageway 40 at the second end 28 of the nut body 22.

With continued reference to FIG. 14C, pressure is applied in any convenient manner to maintain the upper and lower dies 166 and 168, respectively, in position relative to one another in the passageway 40 of the nut body 22. With reference now to FIG. 14D, polymer is moved through passageway 188 of the injection die 168 and injected into the mold cavity 180 (see FIG. 14C). After the polymer sets, the die 168 is moved away from the second end 28 of the nut body 22 (see FIG. 14E) and the die 166 is moved out of the nut body 22 (see FIG. 14F) leaving the molded insert 99 in the nut body 22 of the torque nut 160. The surface 102 of the injection-molded insert 99 can have a mark or flash 179 from sprue (shown only in FIG. 14F) which is characteristic of the injection-molding process. To prevent sticking of the dies to the formed insert, mold release material can be provided on the ends 170 and 172 of the dies 166 and 168, respectively.

The surface 102 of the insert 99 of the torque nut 160 is spaced from the second end 28 of the nut body 22, and the surface 104 of the insert 99 is spaced from the first end 26 of the body 22 of the torque nut 160. As can now be appreciated, the invention is not limited to the position of the insert in the threaded passageway 40, for example, the surface 102 of the insert 99 can be at the second end 28 of the nut body 22 as shown in FIG. 1 or spaced from the second end 28 of the nut body 22 as shown in FIG. 14F. Although the insert can be at any position within the passageway of the nut body, it can be appreciated that the surface 104 of the insert is spaced from the first end of the nut body 22 to thread the end portion 58 of the threaded shaft into the first end 26 of the torque nut.

In a non-limiting embodiment of the invention, a low friction material, e.g., but not limiting to, oil or grease, is moved through passageway 190 of the forming die 166 (see FIG. 14C) at the start of the molding process to flow the low friction material over the threads. More particularly, grease is moved through the passageway 190 in the die 166 into the mold cavity 180. The heat from the polymer heats the forming die 166 and the grease, reducing the viscosity of the grease to flow the grease through the passageway 190 and over the internal threads 32 in a direction toward the injection die 168. The polymer injected between the dies 166 and 168 contains the layer of grease in the upper threaded portion of the nut body. In this manner, when the insert fractures, the pieces of the insert on the internal threads 32 more readily falls away from the threads 32.

The invention is not limited to the spaced distance of the periphery of the insert and the nadir 36 of the threads 27. In one non-limiting embodiment of the invention, the periphery 84 of the insert 24 as shown in FIG. 3 is in surface contact with the nadir 36 of the threads 32, and in another non-limiting embodiment of the invention, the periphery of the insert, e.g., periphery 196 of the insert 126 is spaced from the nadir 36 of the threads 32, for example as shown in FIG. 7A. It has been determined that the insert more readily falls out when the periphery of the insert is spaced from the nadir 36 rather than in contact with the nadir 36 of the threads 32. Although both non-limiting embodiments are acceptable to practice the invention, in the preferred practice of the invention the periphery of the insert 24 is spaced from the nadir 36 of the internal threads 32. Further, as the distance of the periphery of the insert from the nadir 36 increases, the residual torque required after the insert shears to move the fragments of the insert out of the nut body decreases. In the practice of the invention, although not limiting thereto, the distance between the periphery of the insert and the nadir 36 of the internal threads is in the range of greater than 0 to 25% of the thread height, preferably in the range of greater than 0 to 20% of the thread height, and, more preferably, in the range of greater than 0 to 15% of the thread height. In a non-limiting embodiment of the invention for a ¾ inch nut, the spaced distance between the periphery of the insert and the nadir of the threads was in the range of 0.005 to 0.100 inch. As can now be appreciated, the tabs 86 of the insert 24 engaging the internal grooves 30 prevents rotation of the insert 24 along the internal threads 32.

The rate of injection of the polymer into the mold cavity 180 is not limiting to the invention. It has been observed, however, that a fast injection of the polymer, e.g., 1 to 3 seconds, into the mold cavity 180 fills more of the mold cavity 180 (see FIG. 14C), e.g., reduces the distance between the periphery of the insert and the nadir 36 of the threads 32 than a slow injection of the polymer, e.g., 6 to 20 seconds into the mold cavity. Further, it has been observed that a slow injection of the polymer at high pressure, e.g., but not limiting to the invention, 1,000 to 10,000 PSIG, provides intimate contact with the apex 34 of the internal threads 32 but, as the polymer slowly moves between the threads 32, the thread root cooling prevents the polymer from completely filling the thread root, for example, prevents the polymer from contacting the nadir 36 of the internal threads 32. On the other hand, with fast injection, the thread root can be completely filled, and the polymer is in surface contact with the nadir 36.

Polymer materials that can be used in the practice of the invention include but are not limited to any thermoset or thermoplastic material including but not limited to polycarbonate, polystyrene, PMMA, polyolefin, phenolics, polyamides, polyamide-imides, polyesters, polyvinylchlorides, urea formaldehyde, melamine formaldehyde, and combinations thereof but not limited thereto are discussed below.

As can be appreciated, the art of injection molding is well known and a discussion in more detail than the discussion presented above to understand and practice the invention is not deemed necessary.

As can now be appreciated, the invention is not limited to the manner in which the insert 24 is mounted in the nut body 22, and the insert 24 can be mounted in the nut body 22 in any convenient manner. For example, the second open end 28 of the nut body 22 can be positioned on a tray having a release agent, for example, as disclosed in U.S. Pat. No. 4,556,350, which patent is hereby incorporated by reference. A liquid epoxy is poured into the threaded passageway 40 of the nut body 22 and flows into the grooves 30 at the second end 28 of the nut body 22. The liquid resin cures to form the insert of the torque nut 20. The surface of the threaded passageway 40 does not have to be cleaned as disclosed in U.S. Pat. No. 4,556,350. Debris, e.g., machine chips and lubrication, can remain on the threads 32 because the tabs 86 of the insert 24 engaging the internal grooves 30 prevents rotation of the insert 24 in the nut body 22.

In one non-limiting embodiment of the invention, the torque nut of the invention is used with the mine roof support system described in, U.S. Pat. No. 6,619,888, which patent is hereby incorporated by reference.

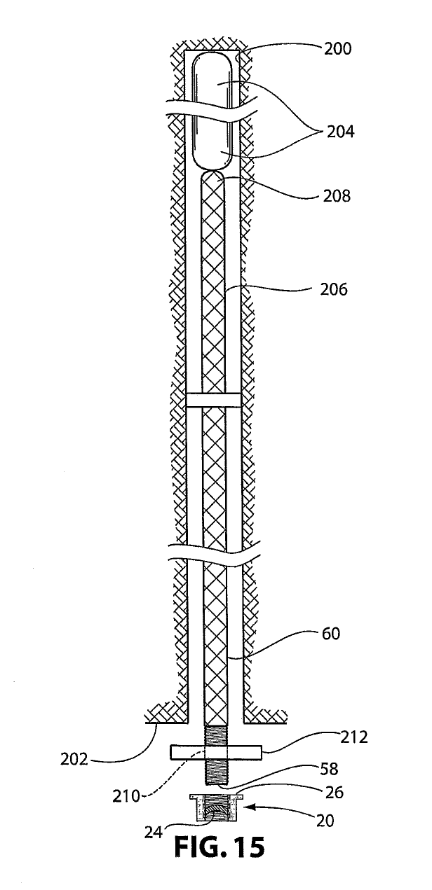

With reference to FIG. 15, bore hole 200 is made in earth and rock in a roof 202 of a mine. The bore hole 200 is particularly adapted to receiving a resin/catalyst cartridge 204 and a rock-bolt or anchor 206, e.g., a rebar having the threaded shaft 60 and the threaded end portion 58 (also see FIG. 5). The resin/catalyst cartridge 204 including both a resin and a catalyst, is inserted into the bore hole 200 defined by the mine roof 202 and, thereafter, end 208 of the rock-bolt 206 is inserted into the bore hole 200. The threaded end portion 58 of the rock-bolt 206 extends out of the bore hole 200. Orifice 210 defined in bearing plate or truss shoe 212 of the type used in the art is placed on the threaded end portion 58, and the first end 26 of the torque nut 20 is rotated onto the threaded end portion 58 of the rock-bolt 206.

The torque nut 20 is rotated until the insert or delay stopper plug 24 of the torque nut 20 engages the end 58 of the rock-bolt 206, causing the rock-bolt 206 to rotate in the bore hole 200, moving the end 208 of the rock-bolt 206 into contact with and rupturing the resin/catalyst cartridge 204. Continued rotation of torque nut 20 rotates the rock-bolt 206 to mix the resin/catalyst in the cartridge 204 to form an adhesive or grout. As the adhesive/grout cures, the rotation of the torque nut 20 and rock-bolt 206 can no longer continue with the uniform torque previously applied. As the torque nut 20 is further rotated, the now stationary rock-bolt 206 applies force to the insert 24, causing the insert 24 to fracture and fall from the second end 28 of the nut body 22. The externally-threaded end portion 58 of the rock-bolt 206 is rotated through the second end 28 of the nut body 22 of the torque nut 20, allowing the torque nut 20 to advance along a length of the rock-bolt 206. In this manner, the torque nut 20 can be further threaded snugly to move the flanged end 26 of the torque nut 20 against the bearing plate 212 to tension the bearing plate 212 against the mine roof 202.

As can be appreciated, the invention is not limited to the type of bearing plate or truss shoe 212 or bearing system that is secured to the mine roof 202 by the torque nut 20 of the invention. Further, as can be appreciated the invention is not limited to a mine roof and the invention can be practiced on a mine wall, side of a hill, a concrete retainer wall, or concrete floor.

The resin used to make the insert of the invention is not limiting to the invention and the material and configuration of the insert or delay stopper plug is selected to provide adequate break out torque, i.e., sufficient to mix the resin/catalyst and fracture the insert when the adhesive/grout cures without weakening the bond of the grout between the bore wall and the rock-bolt or anchor. For example and not limiting to the invention, if the required torque to fracture the insert 24 is too high, the resin holding the rock-bolt 206 in the bore hole 200 can be weakened. It has been determined that an insert that fractures when a torque in the range of 30 to 250 foot pounds is sufficient to fracture the resin/catalyst cartridge, mix the resin/catalyst, and fracture the insert without damaging or weakening the bond of the adhesive or grout.

In one non-limiting embodiment of the invention directed only to the insert 24, the torque nut 20 includes a nut body 22, which is a ¾ inch.times.10 threads per inch TPI flange nut, and has four grooves each having a diameter of 1/16 of an inch. The insert 24 of the torque nut 20 has a thickness of ⅜ inch as measured between the surfaces 102 and 104, the tabs have a diameter of about 1/16 of an inch and are made of polycarbonate. The insert 24 is injection molded in the passageway of the nut body 22 using the injection method described above and illustrated in FIGS. 14A-14F. As can now be appreciated, parameters for the inserts shown in FIGS. 9-13 can now be determined.

The invention is not limited to an insert made of polycarbonate and other materials discussed above can be used.

While specific embodiments of the invention have been described in detail, it will be appreciated by those skilled in the art that various modifications and alternatives to those details can be developed in light of the overall teachings of the disclosure and that the presently preferred embodiments described herein are meant to be illustrative only and not limiting as to the scope of the invention, which is to be given the full breadth of the appended claims and any and all equivalents thereof.

The invention claimed is:

1. A torque nut, comprising:
a body having a first end, an opposite second end, an outer surface between the first end and the second end, an interior passageway connecting the first and second ends of the body, the passageway having a threaded surface portion, and at least one groove extending from the first end toward the second end, wherein the at least one groove is spaced from the outer surface of the body and has an opening communicating with the interior passageway; and
a breakaway insert having a major body portion and a tab connected to the major body portion, wherein the major body portion of the insert is in the passageway and the tab is in the at least one groove, wherein the tab connected to the major body portion prevents rotation of the insert in the passageway.

2. The torque nut of claim 1, wherein the periphery of the major body portion of the insert engages selected apexes of the threaded surface portion.

3. The torque nut of claim 2, wherein the major body portion of the insert has a mark from sprue as is characteristic of injection-molded parts and the insert is securely mounted in the passageway.

4. The torque nut of claim 2, wherein the at least one groove of the body has a first end and an opposite second end, wherein the first end of the at least one groove is at the first end of the body and the second end of the at least one groove is spaced from the second end of the body.

5. The torque nut of claim 4, wherein the threaded surface portion of the passageway of the body extends from the first end of the body to the second end of the body.

6. The torque nut of claim 4, wherein the threaded surface portion of the passageway has a first end spaced from the first end of the body and an opposite second end spaced from the second end of the body.

7. The torque nut of claim 2, wherein the at least one groove is a first groove and the body further comprises a second groove, a third groove and a fourth groove, wherein the second, the third and the fourth grooves are each spaced from the outer surface of the body and communicate with the passageway of the body, each of the first, the second, the third and the fourth grooves have a first end and an opposite second end with the first end of each of the first, second, third and fourth grooves at the first end of the body, and the first, the second, the third and the fourth grooves are spaced from one another, wherein a first segment of the interior passageway is between an opening of the first groove and an opening of the second groove, a second segment of the passageway is between the opening of the second groove and an opening of the third groove, a third segment of the passageway is between the opening of the third groove and an opening of the fourth groove, and a fourth segment of the passageway is between the openings of the fourth and the first grooves.

8. The torque nut of claim 7, wherein the threaded surface portion of the passageway extends from the first end of the body to the second end of the body, and the second end of the first, the second, the third and the fourth grooves are spaced from the second end of the body to define a first portion of the passageway, wherein the first portion of the passageway has continuous threads, and the portion of the passageway between the second end of the first, the second, the third, and the fourth grooves and the first end of the body defines a second portion of the passageway, wherein the second portion of the passageway comprises the first, the second, the third and the fourth segments of the passageway and each of the first, the second, the third, and the fourth segments of the passageway have threads.

9. The torque nut of claim 8, wherein the tab is a first tab and the insert further comprises a second tab connected to the major body portion, a third tab connected to the major body portion and a fourth tab connected to the major body portion, wherein the second tab, the third tab and the fourth tab are in the second groove, the third groove and the fourth groove, respectively.

10. The torque nut of claim 2, wherein portions of the periphery of the major body portion of the insert are between adjacent threads and spaced from the nadir of the adjacent threads.

11. The torque nut of claim 2, wherein a layer of a material selected from the group of a non-friction material, a low friction material, and combinations thereof is between the threads and selected surface portions of the insert engaged by the threads.

12. The torque nut of claim 1, wherein the insert is spaced from the second end of the body, and the first end of the body further comprises a flange.

13. The torque nut of claim 1, wherein the insert is spaced from the first end of the body.

14. The torque nut of claim 2, wherein the insert has a first surface facing the first end of the body and a second surface facing the second end of the body, wherein the first surface of the insert has a shape selected from the group of a convex surface, a rounded convex surface, a cone-shaped convex surface, a flat surface, and combinations thereof, and wherein the second surface of the insert has a shape selected from the group of a concave surface, a rounded concave surface, a cone-shaped concave surface, a flat surface, and combinations thereof.

15. The torque nut of claim 1, further comprising one end of a mine rock-bolt threaded in one of the ends of the body.

16. A method of making a torque nut having a breakaway insert, comprising the steps of:
providing a nut body having a first end, an opposite second end, an outer wall between the first end and the second end, a passageway connecting the first end and the second end of the nut body, the passageway having a threaded portion, at least one groove extending from the first end toward the second end, wherein the groove is spaced from the outer wall of the nut body and has an opening facing the interior of the passageway;
forming a breakaway insert in the passageway, wherein a portion of the insert defined as a major body portion is in the passageway and a portion of the insert defined as a tab is in the at least one groove, wherein the tab connected to the major body portion prevents rotation of the insert in the passageway.

17. The method of claim 16, wherein the periphery of the major body portion of the insert engages selected apexes of the threaded surface portion.

18. The method of claim 17, wherein the forming of a breakaway insert in the passageway comprises:
providing an end of a forming die in one of the ends of the nut body;
providing an end of an injection die in the other end of the nut body, with the ends of the upper die and the injection die spaced a predetermined distance from one another to provide a cavity;
moving an injection-molding material into the cavity to form a thin cover over surface portions of the end of the forming die to prevent the injection-molding material from moving between the threads of the passageway and adjacent walls of the upper die and into the at least one groove; and
moving the dies out of the nut body to provide the torque nut having the major body portion of the insert in the passageway and the tab of the insert in the at least one groove.

19. The method of claim 16, wherein the injection-molding material is a fluid polymer and the step of moving the dies out of the nut body is practiced after the fluid polymer solidifies, and further comprising the step of:
moving a non-friction or low-friction material through a passageway in the forming die onto selected surface portions of threads, wherein said step of moving a non-friction or low-friction material is practiced prior to the step of moving a fluid polymer into the cavity.

20. A method of securing an anchor in a structure, comprising the steps of:
providing a torque nut comprising:
a body having a first end, an opposite second end, an outer surface between the first end and the second end, an interior passageway connecting the first and second ends of the body, the passageway having a threaded surface portion, and at least one groove extending from the first end toward the second end, wherein the at least one groove is spaced from the outer surface of the body and has an opening communicating with the interior passageway; and
a breakaway insert having a major body portion and a tab connected to the major body portion, wherein the major body portion of the insert is in the passageway and the tab is in the at least one groove, wherein the tab connected to the major body portion prevents rotation of the insert in the passageway;
threading an end of a rock-bolt into an end of the nut body;
positioning opposite an end of the rock-bolt in a bore hole in the structure, with the opposite end of the rock-bolt engaging a capsule having a resin component and a catalyst component; and
rotating the rock-bolt to fracture the capsule and/or to mix the resin and catalyst components to secure the opposite end of the rock-bolt in the bore hole.
